(19) United States
(12) Patent Application Publication
(10) Pub. No.: US 2024/0027572 A1
(43) Pub. Date: Jan. 25, 2024

(54) METHOD AND APPARATUS TO ENABLE RADAR MODE FOR WI-FI DEVICES

(71) Applicant: Samsung Electronics Co., Ltd., Suwon-si (KR)

(72) Inventors: Abhishek Sehgal, Frisco, TX (US); Vishnu Vardhan Ratnam, Plano, TX (US); Guanbo Chen, McKinney, TX (US); Hao Chen, Allen, TX (US)

(21) Appl. No.: 18/348,256

(22) Filed: Jul. 6, 2023

Related U.S. Application Data
(60) Provisional application No. 63/390,575, filed on Jul. 19, 2022.

(51) Int. Cl. G01S 7/00; G01S 7/02; G01S 13/10

(52) U.S. Cl. CPC G01S 7/006; G01S 7/0235; G01S 13/106; H04W 84/12

(57) ABSTRACT

A method includes obtaining radar pulse configuration information at an electronic device. The method also includes generating a data unit of a Wi-Fi communications protocol based on the radar pulse configuration information, the data unit comprising a preamble and a data field. The method also includes transmitting at least one radar pulse within a duration of the data field. The method also includes receiving at least one reflection of the at least one radar pulse within the duration of the data field. The method also includes processing the at least one reflection to determine a distance between an object and the electronic device.

### CROSS-REFERENCE TO RELATED APPLICATION AND CLAIM OF PRIORITY

This application claims priority under 35 U.S.C. § 119(e) to U.S. Provisional Patent Application No. 63/390,575 filed on Jul. 19, 2022, which is hereby incorporated by reference in its entirety.

### TECHNICAL FIELD

This disclosure relates generally to wireless communications systems. Embodiments of this disclosure relate to methods and apparatuses to enable radar mode for Wi-Fi devices.

### BACKGROUND

IEEE 802.11 is a CSMA/CA-based communication framework in which access is provided using distributed coordination functions. Currently, the synchronization mechanisms used in IEEE 802.11 have been repurposed for Wi-Fi sensing, but since the transmitter and receiver do not utilize the same clock generator, the receiver needs expensive computation to recover the synchronization. Even with perfect synchronization recovery algorithms, the leftover channel state information loses the richness of information in channel variability, which is key for tasks like movement detection and vital signs monitoring.

### SUMMARY

Embodiments of the present disclosure provide methods and apparatuses to enable radar mode for Wi-Fi devices.

In one embodiment, a method includes obtaining radar pulse configuration information at an electronic device. The method also includes generating a data unit of a Wi-Fi communications protocol based on the radar pulse configuration information, the data unit comprising a preamble and a data field. The method also includes transmitting at least one radar pulse within a duration of the data field. The method also includes receiving at least one reflection of the at least one radar pulse within the duration of the data field. The method also includes processing the at least one reflection to determine a distance between an object and the electronic device.

In another embodiment, a device includes a transceiver and a processor operably connected to the transceiver. The processor is configured to: obtain radar pulse configuration information; generate a data unit of a Wi-Fi communications protocol based on the radar pulse configuration information, the data unit comprising a preamble and a data field; transmit at least one radar pulse within a duration of the data field; receive at least one reflection of the at least one radar pulse within the duration of the data field; and process the at least one reflection to determine a distance between an object and the device.

In another embodiment, a non-transitory computer readable medium includes program code that, when executed by a processor of a device, causes the device to: obtain radar pulse configuration information; generate a data unit of a Wi-Fi communications protocol based on the radar pulse configuration information, the data unit comprising a preamble and a data field; transmit at least one radar pulse within a duration of the data field; receive at least one reflection of the at least one radar pulse within the duration of the data field, and process the at least one reflection to determine a distance between an object and the device.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C. As used herein, such terms as “1st” and “2nd,” or “first” and “second” may be used to simply distinguish a corresponding component from another and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used herein, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to various embodiments of the present disclosure;

FIG. 2A illustrates an example AP according to various embodiments of the present disclosure;

FIG. 2B illustrates an example STA according to various embodiments of the present disclosure;

FIG. 3 illustrates a high level architecture of an example common monostatic radar system according to various embodiments of the present disclosure;

FIG. 4 illustrates a diagram comparing Wi-Fi original and Wi-Fi TWT packet exchanges between devices according to various embodiments of the present disclosure;

FIG. 5 illustrates an example TWT parameter set field used for TWT parameter negotiation according to various embodiments of the present disclosure;

FIG. 6 illustrates an offset in a TWT session according to various embodiments of the present disclosure;

FIG. 7 illustrates an example TWT information frame according to various embodiments of the present disclosure;

FIG. 8 illustrates an example of early termination of TWT according to various embodiments of the present disclosure;

FIG. 9 illustrates an example preamble in an 802.11 OFDM PLCP protocol data unit according to various embodiments of the present disclosure;

FIG. 10 illustrates an example Wi-Fi node that includes a duplexer switch for use in Wi-Fi according to various embodiments of the present disclosure;

FIG. 11 illustrates an example operation timeline for Wi-Fi radar mode using a single antenna according to various embodiments of the present disclosure;

FIGS. 12A and 12B illustrate example formats for packets for monostatic radar operation using a single antenna according to various embodiments of the present disclosure;

FIG. 13 illustrates an example process for configuring monostatic radar mode on a Wi-Fi node with a single antenna according to various embodiments of the present disclosure;

FIG. 14 illustrates an example RF circulator according to various embodiments of the present disclosure;

FIG. 15 illustrates an example process for performing radar operation using reserved TXOP with CTS-to-self according to various embodiments of the present disclosure;

FIG. 16 illustrates an example timeline in which radar operation is enabled using CTS-to-self according to various embodiments of the present disclosure;

FIG. 17 illustrates an example timeline showing how time can be divided between radar mode and communication for a Wi-Fi node using TWT according to various embodiments of the present disclosure;

FIG. 18 illustrates an example process for assigning the TWT Interval and TWT SP Duration based on the priority of the communications traffic according to various embodiments of the present disclosure; and

FIG. 19 illustrates a flow chart of a method for enabling radar mode for Wi-Fi devices according to various embodiments of the present disclosure.

### DETAILED DESCRIPTION

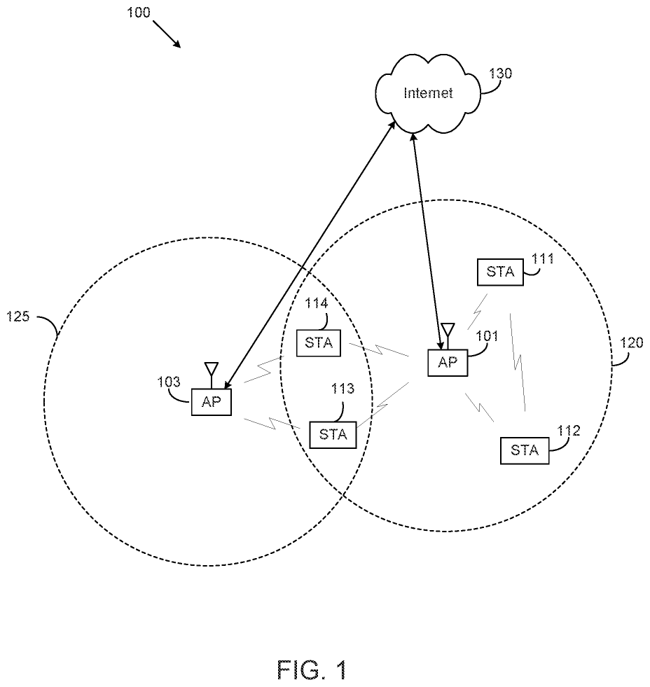

FIGS. 1 through 19, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

Aspects, features, and advantages of the disclosure are readily apparent from the following detailed description, simply by illustrating a number of particular embodiments and implementations, including the best mode contemplated for carrying out the disclosure. The disclosure is also capable of other and different embodiments, and its several details can be modified in various obvious respects, all without departing from the spirit and scope of the disclosure. Accordingly, the drawings and description are to be regarded as illustrative in nature, and not as restrictive. The disclosure is illustrated by way of example, and not by way of limitation, in the figures of the accompanying drawings.

The present disclosure covers several components which can be used in conjunction or in combination with one another or can operate as standalone schemes. Certain embodiments of the disclosure may be derived by utilizing a combination of several of the embodiments listed below. Also, it should be noted that further embodiments may be derived by utilizing a particular subset of operational steps as disclosed in each of these embodiments. This disclosure should be understood to cover all such embodiments.

FIG. 1 illustrates an example wireless network 100 according to various embodiments of the present disclosure. The embodiment of the wireless network 100 shown in FIG. 1 is for illustration only. Other embodiments of the wireless network 100 could be used without departing from the scope of this disclosure.

The wireless network 100 includes access points (APs) 101 and 103. The APs 101 and 103 communicate with at least one network 130, such as the Internet, a proprietary Internet Protocol (IP) network, or other data network. The AP 101 provides wireless access to the network 130 for a plurality of stations (STAs) 111-114 within a coverage area 120 of the AP 101. The APs 101-103 may communicate with each other and with the STAs 111-114 using Wi-Fi or other WLAN (wireless local area network) communication techniques. The STAs 111-114 may communicate with each other using peer-to-peer protocols, such as Tunneled Direct Link Setup (TDLS).

Depending on the network type, other well-known terms may be used instead of “access point” or “AP,” such as “router” or “gateway.” For the sake of convenience, the term “AP” is used in this disclosure to refer to network infrastructure components that provide wireless access to remote terminals. In WLAN, given that the AP also contends for the wireless channel, the AP may also be referred to as a STA. Also, depending on the network type, other well-known terms may be used instead of “station” or “STA,” such as “mobile station,” “subscriber station,” “remote terminal,” “user equipment,” “wireless terminal,” or “user device.” For the sake of convenience, the terms “station” and “STA” are used in this disclosure to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.).

Dotted lines show the approximate extents of the coverage areas 120 and 125, which are shown as approximately circular for the purposes of illustration and explanation only. It should be clearly understood that the coverage areas associated with APs, such as the coverage areas 120 and 125, may have other shapes, including irregular shapes, depending upon the configuration of the APs and variations in the radio environment associated with natural and man-made obstructions.

As described in more detail below, one or more of the APs may include circuitry and/or programming to enable radar mode for Wi-Fi devices. Although FIG. 1 illustrates one example of a wireless network 100, various changes may be made to FIG. 1. For example, the wireless network 100 could include any number of APs and any number of STAs in any suitable arrangement. Also, the AP 101 could communicate directly with any number of STAs and provide those STAs with wireless broadband access to the network 130. Similarly, each AP 101 and 103 could communicate directly with the network 130 and provide STAs with direct wireless broadband access to the network 130. Further, the APs 101 and/or 103 could provide access to other or additional external networks, such as external telephone networks or other types of data networks.

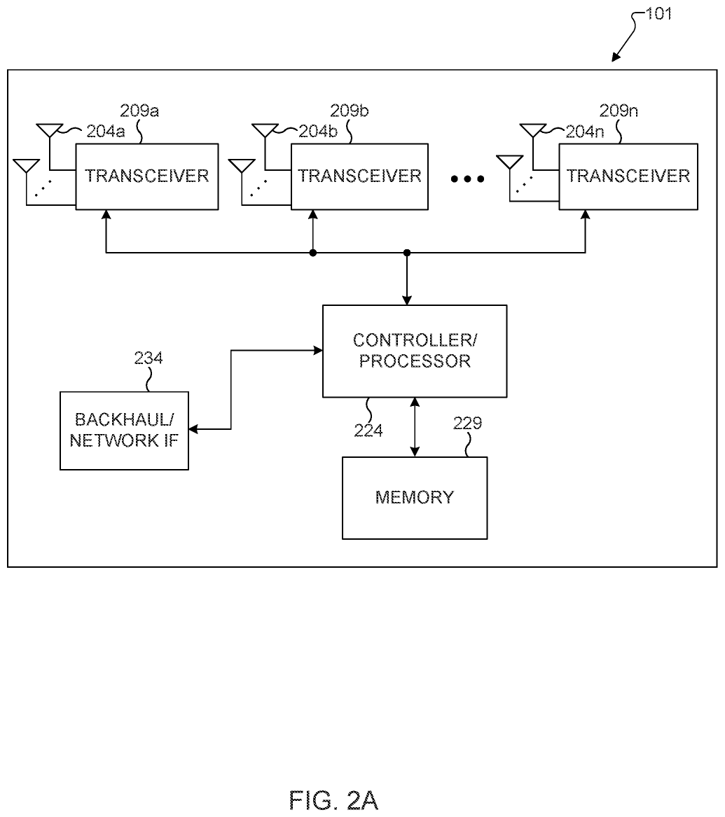

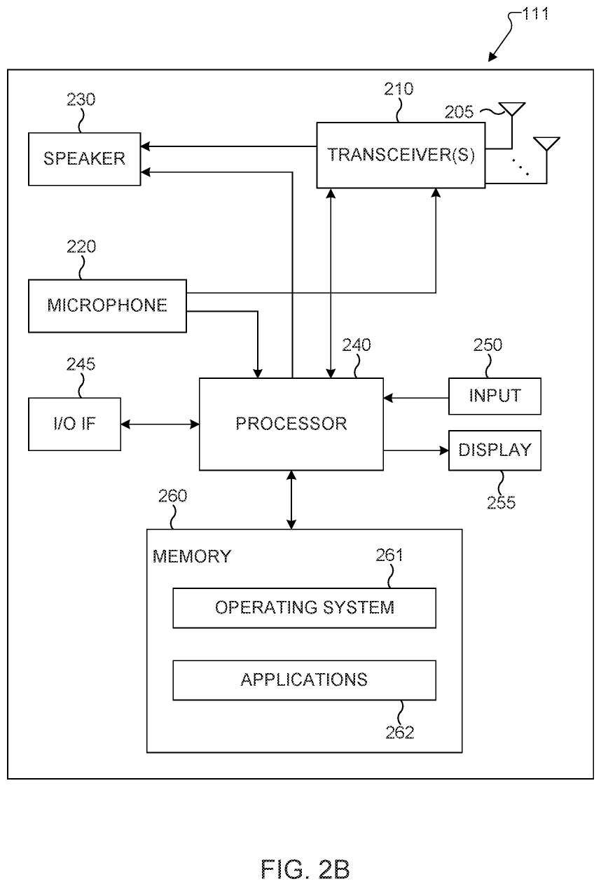

FIG. 2A illustrates an example AP 101 according to various embodiments of the present disclosure. The embodiment of the AP 101 illustrated in FIG. 2A is for illustration only, and the AP 103 of FIG. 1 could have the same or similar configuration. However, APs come in a wide variety of configurations, and FIG. 2A does not limit the scope of this disclosure to any particular implementation of an AP.

The AP 101 includes multiple antennas 204a-204n and multiple transceivers 209a-209n. The AP 101 also includes a controller/processor 224, a memory 229, and a backhaul or network interface 234. The transceivers 209a-209n receive, from the antennas 204a-204n, incoming radio frequency (RF) signals, such as signals transmitted by STAs 111-114 in the network 100. The transceivers 209a-209n down-convert the incoming RF signals to generate IF or baseband signals. The IF or baseband signals are processed by receive (RX) processing circuitry in the transceivers 209a-209n and/or controller/processor 224, which generates processed baseband signals by filtering, decoding, and/or digitizing the baseband or IF signals. The controller/processor 224 may further process the baseband signals.

Transmit (TX) processing circuitry in the transceivers 209a-209n and/or controller/processor 224 receives analog or digital data (such as voice data, web data, e-mail, or interactive video game data) from the controller/processor 224. The TX processing circuitry encodes, multiplexes, and/or digitizes the outgoing baseband data to generate processed baseband or IF signals. The transceivers 209a-209n up-converts the baseband or IF signals to RF signals that are transmitted via the antennas 204a-204n.

The controller/processor 224 can include one or more processors or other processing devices that control the overall operation of the AP 101. For example, the controller/processor 224 could control the reception of forward channel signals and the transmission of reverse channel signals by the transceivers 209a-209n in accordance with well-known principles. The controller/processor 224 could support additional functions as well, such as more advanced wireless communication functions. For instance, the controller/processor 224 could support beam forming or directional routing operations in which outgoing signals from multiple antennas 204a-204n are weighted differently to effectively steer the outgoing signals in a desired direction. The controller/processor 224 could also support OFDMA operations in which outgoing signals are assigned to different subsets of subcarriers for different recipients (e.g., different STAs 111-114). Any of a wide variety of other functions could be supported in the AP 101 by the controller/processor 224 including enabling radar mode for Wi-Fi devices. In some embodiments, the controller/processor 224 includes at least one microprocessor or microcontroller. The controller/processor 224 is also capable of executing programs and other processes resident in the memory 229, such as an OS. The controller/processor 224 can move data into or out of the memory 229 as required by an executing process.

The controller/processor 224 is also coupled to the backhaul or network interface 234. The backhaul or network interface 234 allows the AP 101 to communicate with other devices or systems over a backhaul connection or over a network. The interface 234 could support communications over any suitable wired or wireless connection(s). For example, the interface 234 could allow the AP 101 to communicate over a wired or wireless local area network or over a wired or wireless connection to a larger network (such as the Internet). The interface 234 includes any suitable structure supporting communications over a wired or wireless connection, such as an Ethernet or RF transceiver. The memory 229 is coupled to the controller/processor 224. Part of the memory 229 could include a RAM, and another part of the memory 229 could include a Flash memory or other ROM.

As described in more detail below, the AP 101 may include circuitry and/or programming for enabling radar mode for Wi-Fi devices. Although FIG. 2A illustrates one example of AP 101, various changes may be made to FIG. 2A. For example, the AP 101 could include any number of each component shown in FIG. 2A. As a particular example, an access point could include a number of interfaces 234, and the controller/processor 224 could support routing functions to route data between different network addresses. Alternatively, only one antenna and transceiver path may be included, such as in legacy APs. Also, various components in FIG. 2A could be combined, further subdivided, or omitted and additional components could be added according to particular needs.

FIG. 2B illustrates an example STA 111 according to various embodiments of the present disclosure. The embodiment of the STA 111 illustrated in FIG. 2B is for illustration only, and the STAs 112-114 of FIG. 1 could have the same or similar configuration. However, STAs come in a wide variety of configurations, and FIG. 2B does not limit the scope of this disclosure to any particular implementation of a STA.

The STA 111 includes antenna(s) 205, transceiver(s) 210, a microphone 220, a speaker 230, a processor 240, an input/output (I/O) interface (IF) 245, an input 250, a display 255, and a memory 260. The memory 260 includes an operating system (OS) 261 and one or more applications 262.

The transceiver(s) 210 receives from the antenna(s) 205, an incoming RF signal (e.g., transmitted by an AP 101 of the network 100). The transceiver(s) 210 down-converts the incoming RF signal to generate an intermediate frequency (IF) or baseband signal. The IF or baseband signal is processed by RX processing circuitry in the transceiver(s) 210 and/or processor 240, which generates a processed baseband signal by filtering, decoding, and/or digitizing the baseband or IF signal. The RX processing circuitry sends the processed baseband signal to the speaker 230 (such as for voice data) or is processed by the processor 240 (such as for web browsing data).

TX processing circuitry in the transceiver(s) 210 and/or processor 240 receives analog or digital voice data from the microphone 220 or other outgoing baseband data (such as web data, e-mail, or interactive video game data) from the processor 240. The TX processing circuitry encodes, multiplexes, and/or digitizes the outgoing baseband data to generate a processed baseband or IF signal. The transceiver(s) 210 up-converts the baseband or IF signal to an RF signal that is transmitted via the antenna(s) 205.

The processor 240 can include one or more processors and execute the basic OS program 261 stored in the memory 260 in order to control the overall operation of the STA 111. In one such operation, the processor 240 controls the reception of forward channel signals and the transmission of reverse channel signals by the transceiver(s) 210 in accordance with well-known principles. The processor 240 can also include processing circuitry configured to enable radar mode for Wi-Fi devices. In some embodiments, the processor 240 includes at least one microprocessor or microcontroller.

The processor 240 is also capable of executing other processes and programs resident in the memory 260, such as operations for enabling radar mode for Wi-Fi devices. The processor 240 can move data into or out of the memory 260 as required by an executing process. In some embodiments, the processor 240 is configured to execute a plurality of applications 262, such as applications to enable radar mode for Wi-Fi devices. The processor 240 can operate the plurality of applications 262 based on the OS program 261 or in response to a signal received from an AP. The processor 240 is also coupled to the I/O interface 245, which provides STA 111 with the ability to connect to other devices such as laptop computers and handheld computers. The I/O interface 245 is the communication path between these accessories and the processor 240.

The processor 240 is also coupled to the input 250, which includes for example, a touchscreen, keypad, etc., and the display 255. The operator of the STA 111 can use the input 250 to enter data into the STA 111. The display 255 may be a liquid crystal display, light emitting diode display, or other display capable of rendering text and/or at least limited graphics, such as from web sites. The memory 260 is coupled to the processor 240. Part of the memory 260 could include a random-access memory (RAM), and another part of the memory 260 could include a Flash memory or other read-only memory (ROM).

Although FIG. 2B illustrates one example of STA 111, various changes may be made to FIG. 2B. For example, various components in FIG. 2B could be combined, further subdivided, or omitted and additional components could be added according to particular needs. In particular examples, the STA 111 may include any number of antenna(s)205 for MIMO communication with an AP 101. In another example, the STA 111 may not include voice communication or the processor 240 could be divided into multiple processors, such as one or more central processing units (CPUs) and one or more graphics processing units (GPUs). Also, while FIG. 2B illustrates the STA 111 configured as a mobile telephone or smartphone, STAs could be configured to operate as other types of mobile or stationary devices.

Monostatic Radar.

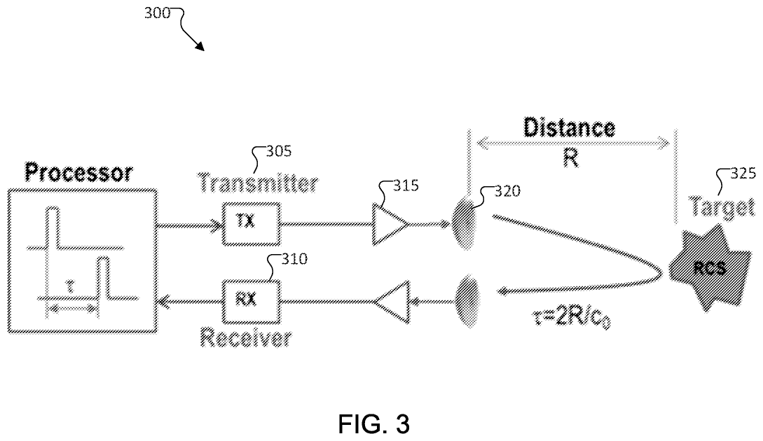

A common type of radar is the “monostatic” radar, characterized by the fact that the transmitter of the radar signal and the receiver for its delayed echo are, for all practical purposes, in the same location. FIG. 3 illustrates a high level architecture of an example common monostatic radar system 300, i.e., the transmitter 305 and receiver 310 are co-located, either by using a common antenna, or are nearly co-located, while using separate, but adjacent antennas. Monostatic radars are assumed coherent, i.e., the transmitter 305 and receiver 310 are synchronized via a common time reference.

In its most basic form, a radar pulse is generated as a realization of a desired “radar waveform,” modulated onto a radio carrier frequency and transmitted through a power amplifier 315 and antenna 320 (such as a parabolic antenna), either omni-directionally or focused into a particular direction. Assuming a “target” 325 at a distance R from the radar location and within the field-of-view of the transmitted signal, the target 325 will be illuminated by RF power density pₜ (e.g., in units of W/m²) for the duration of the transmission. To first order, pₜ can be described as:

$${p}_{t} = \frac{{P}_{T}}{4 π {R}^{2}} {G}_{T} = \frac{{P}_{T}}{4 π {R}^{2}} \frac{{A}_{T}}{( {λ}^{2} / 4 π )} = {P}_{T} \frac{{A}_{T}}{{λ}^{2} {R}^{2}} ,$$

where P_{T} is the transmit power[W]; G_{T}, A_{T} are the transmit antenna gain [dBi] and the effective aperture area [m²]; λ is the wavelength of the radar signal RF carrier signal [m]; and R is the target distance [m]. In this equation, the effects of atmospheric attenuation, multi-path propagation, antenna losses, etc., have been neglected.

The transmit power density impinging onto the target surface will lead to reflections depending on the material composition, surface shape, and dielectric behavior at the frequency of the radar signal. Note that off-direction scattered signals are typically too weak to be received back at the radar receiver 310, so only direct reflections will contribute to a detectable receive signal. In essence, the illuminated area(s) of the target 325 with normal vectors pointing back at the receiver 310 will act as transmit antenna apertures with directivities (gains) in accordance with their effective aperture area(s). The reflected-back power can be described as:

$${p}_{refl} = {p}_{t} {A}_{t} {G}_{t} ∼ {p}_{t} {A}_{t} {r}_{t} \frac{{A}_{t}}{( {λ}^{2} / 4 π )} = {p}_{t} RCS ,$$

where P_{refl} is the effective (isotropic) target-reflected power [W]; Aₜ, rₜ, Gₜ are the effective target area normal to the radar direction [m2], reflectivity of the material and shape [0, . . . , 1], and corresponding aperture gain [dBi]; and RCS is the radar cross section [m²].

Note that the radar cross section, RCS, is an equivalent area that scales proportional to the actual reflecting area-squared, inversely proportional with the wavelength-squared, and is reduced by various shape factors and the reflectivity of the material itself. For a flat, fully reflecting mirror of area Aₜ, large compared with λ², RCS=4πAₜ²/λ². Due to the material and shape dependency, it is generally not possible to deduce the actual physical area of a target 325 from the reflected power, even if the target distance is known (hence the existence of stealth objects that choose material absorption and shape characteristics carefully for minimum RCS).

The target-reflected power at the receiver location results from the reflected-power density at the reverse distance R, collected over the receiver antenna aperture area:

$${P}_{R} = \frac{{P}_{refl}}{4 π {R}^{2}} {A}_{R} = {P}_{T} \cdot RCS \frac{{A}_{T} {A}_{R}}{4 π {λ}^{2} {R}^{4}} ,$$

where P_{R} is the received, target-reflected power [W], and A_{R} is the receiver antenna effective aperture area [m²] (which may be same as A_{T}).

The radar system 300 is usable as long as the receiver signal exhibits sufficient signal-to-noise ratio (SNR), the particular value of which depends on the waveform and detection method used. Generally, in its simplest form:

$$SNR = \frac{{P}_{R}}{kT \cdot B \cdot F} ,$$

where kT is Boltzmann's constant x temperature [W/Hz], B is the radar signal bandwidth [Hz], and F is the receiver noise factor (degradation of receive signal SNR due to noise contributions of the receiver circuit itself).

In case the radar signal is a short pulse of duration (width) Tₚ, it will be apparent that the delay τ between the transmission and reception of the corresponding echo will be equal to r=2 R/c, where c is the speed of light propagation in the medium (air). In case there are several targets at slightly different distances, it will be equally apparent that the individual echos can be distinguished as such only if the delays differ by at least one pulse width, and hence the range resolution of the radar will be ΔR=cΔτ/2=cTₚ/2. Further considering that a rectangular pulse of duration Tₚ exhibits a power spectral density P(f)˜(sin (πfTₚ)/(πfTₚ))² with the first null at its bandwidth B=1/Tₚ, the range resolution of a radar is fundamentally connected with the bandwidth of the radar waveform via ΔR=c/2B.

Wi-Fi and Target Wake Time (TWT).

The next generation IEEE 802.11 WLAN amendment (i.e., IEEE 802.11ax) introduces features for improving peak throughput and efficiency in an environment crowded by many 802.11 devices such as an airport, stadium, and so on. WFA (Wi-Fi alliance) has already launched the Wi-Fi 6 certification program for guaranteeing interoperability between certified products implementing IEEE 802.11ax amendment. In the market, device manufacturers are already starting to release Wi-Fi 6 certified smart mobile devices.

Target Wake Time (TWT), one of the important features of IEEE 802.11ax, enables wake time negotiation between an AP and its STA for improving power efficiency. The negotiated parameters such as the wake interval, wake duration and initial wake time (offset) highly affect latency, throughput, and power efficiency, which are directly related to QoS (quality of service) or customer experiences. Services with different traffic characteristics can have different TWT parameter configurations for better QoS. Additionally, the TWT configuration should adapt to network and service status variation.

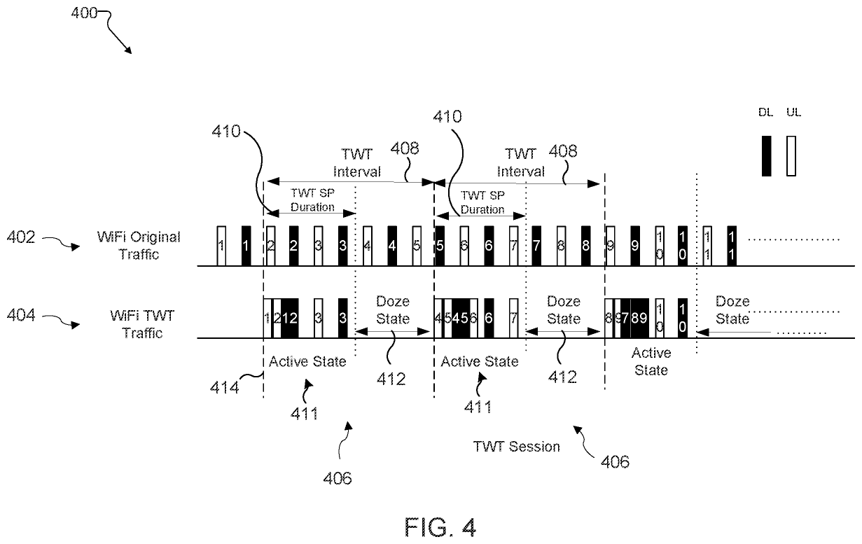

FIG. 4 illustrates a diagram 400 comparing Wi-Fi original and Wi-Fi TWT packet exchanges between devices according to various embodiments of the present disclosure. Specifically, FIG. 4 illustrates two scenarios of exchange of uplink (UL) communication packets and downlink (DL) communication packets (which may be collectively referred to as traffic) between an AP and an associated client STA. First, without wake time negotiation between the AP and the STA (e.g., as seen in the top graph 402), and second, with wake time negotiation between the AP and the STA (e.g., in an IEEE 802.11ax system and as seen in the bottom graph 404). In the top graph 402, there is a regular stream of non-buffered traffic between the AP and the STA, with UL packets being interspersed with DL packets. In this scenario (i.e., without wake time negotiation) there is no option for the STA to enter a doze state or a power save state.

By contrast, in the bottom graph 404, wake time negotiation gives rise to consecutive TWT sessions 406. Each TWT session 406 is defined as the time period from the beginning of a TWT interval 408 to the end of the TWT interval 408. Each TWT session 406 includes two states: an active state 411, defined by a TWT service period (SP) duration 410 (during which the STA is awake to communicate with the AP), and a power save state or doze state 412 (during which the STA is not actively awake or communicating with the AP). As a result of wake time negotiation, power efficiency at the STA is improved without adding too much latency or allowing UL or DL packets to be dropped.

In wake time negotiation, the negotiated TWT parameters include the wake interval (e.g., the TWT interval 408 for each TWT session 406), wake duration (e.g., the TWT SP duration 410 for each TWT session 406), and initial wake time or offset (e.g., indicated by the TWT start time 414). These negotiated parameters highly affect latency, throughput, and power efficiency, which are directly related to the QoS (quality of service) a customer experiences. Services with different traffic characteristics can have different TWT parameter configurations for better QoS. Additionally, the TWT configuration should adapt to network and service status variation.

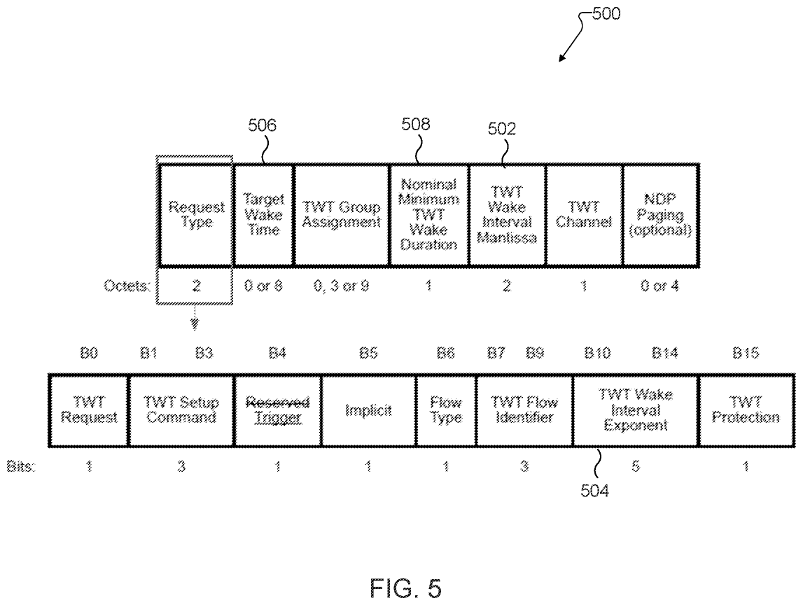

In some embodiments, a TWT parameter set field is used to negotiate the TWT parameters. FIG. 5 illustrates an example TWT parameter set field 500 used for TWT parameter negotiation according to various embodiments of the present disclosure. The TWT agreement is initiated by a STA sending a TWT negotiation request to an AP. Once a TWT agreement is made between the AP and the STA, the STA periodically wakes up to communicate with the AP, where the interval between the successive wake times is jointly specified by the TWT wake interval mantissa 502 and TWT wake interval exponent 504 subfields in the TWT parameter set field 500.

The target wake time 506 and nominal minimum TWT wake duration 508 subfields specify, respectively, the first wake time for the TWT agreement, and the time for which the STA must wait before going to doze state when there is no transmitted traffic after a wake time, which is the TWT SP duration 410 in FIG. 4.

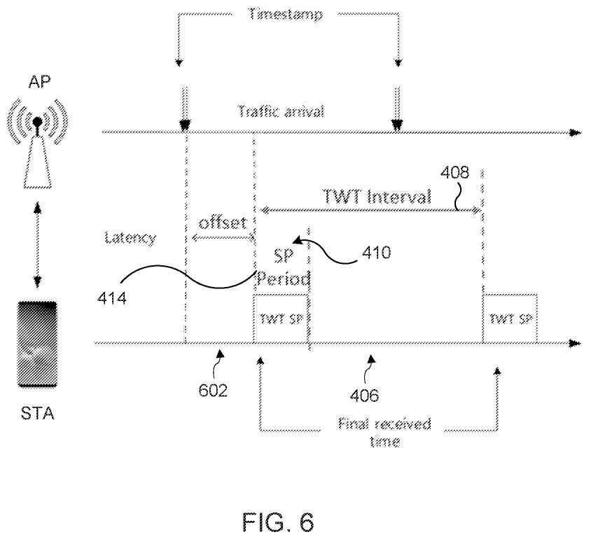

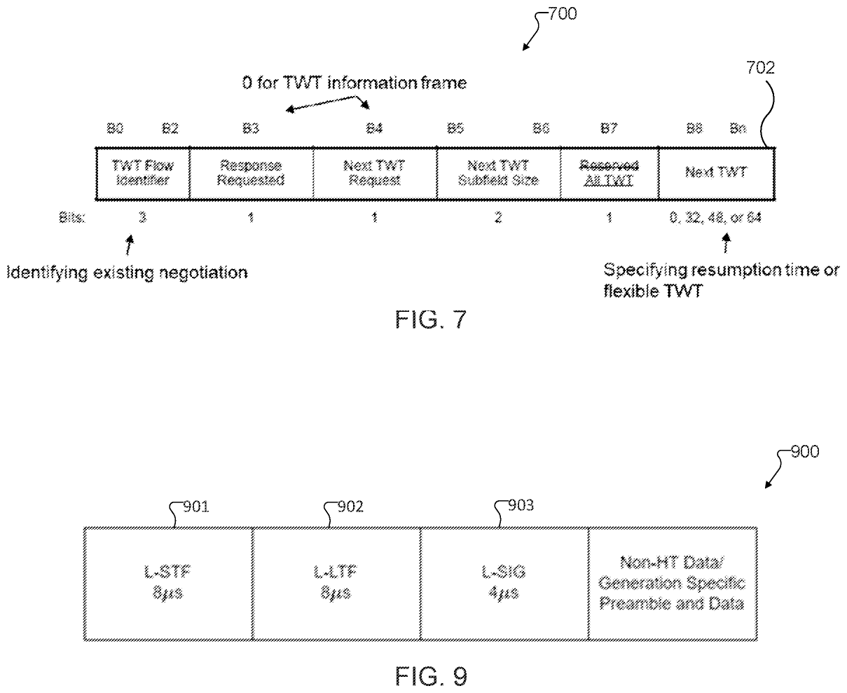

Other than the wake interval and wake duration, offset is also an important impact factor on the user experience, as the offset could affect the latency. FIG. 6 illustrates an offset in a TWT session according to various embodiments of the present disclosure. Different offsets 602 introduce a different additional TWT related latency. The TWT interval 408 and the offset 602 together define the additional latency introduced by TWT. After TWT negotiation setup, the offset 602 can be adjusted by the field “Next TWT” 702 in the example TWT information frame 700 illustrated in FIG. 7.

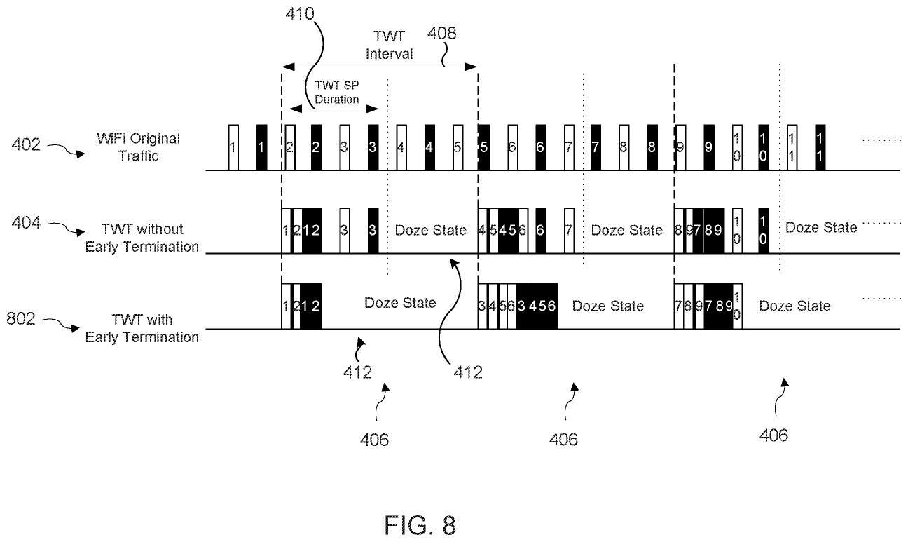

FIG. 8 illustrates an example of early termination of TWT according to various embodiments of the present disclosure. In various embodiments, the actual TWT SP duration 410 is dynamically determined in run time by the aforementioned nominal minimum TWT wake duration, and the STA enters the doze state 412 when a packet is received with EOSP (end of service period) bit set to “1”, or more data bit set to “0”. Depending on whether or not early termination is supported, the time the STA enters the doze state 412 will be slightly different. As shown in the graph 802, if the STA supports early termination then once the STA receives a packet with EOSP bit set to “1” or more data bit “0” the STA can enter doze state 412 (although there could be a slight delay between reception of the packet and entering doze state 412). If the STA does not support early termination, then it will wait until the end of the TWT SP duration 410 to enter doze state 412, as shown in graph 404.

Additionally, to preserve inter-generation co-existence and association, any 802.11 Orthogonal Frequency Division Multiplexing (OFDM) PHY Layer Convergence Procedure (PLCP) legacy preamble can have a consistent format. FIG. 9 illustrates an example preamble 900 in an 802.11 OFDM PLCP protocol data unit (PPDU) according to various embodiments of the present disclosure. As shown in FIG. 9, the preamble 900 includes a non-HT/Legacy Short Training Field (STF), a Long Training Field (LTF) field 902, and a Signal (SIG) field 903. The fields 901-903 are labelled as L-STF, L-LTF and L-SIG, respectively, to distinguish the fields from generation specific fields having the same names.

The L-STF field 901 is used to detect the start of the packet and consists of a standard-defined sequence with good correlation properties. The L-STF field 901 can be used for Coarse Frequency correction. The L-LTF field 902 is used for channel estimation and removing other hardware impairments such as symbol timing offset and frequency offset estimations. The L-SIG field 903 is used to communicate the modulation rate of the following information and also consists of the length of the packet and even parity communication field. The modulation rate and length field are used to set the Network Allocation Vector (NAV). The duration is calculated according to the following:

$$Duration = \frac{{Length}_{L - SIG} * 4}{3 Bytes per symbol} μ sec$$

This is because L-SIG field 903 is transmitted at BPSK and it has 3 bytes per symbol and each symbol is 4 μsec long.

As discussed above, IEEE 802.11 is an opportunistic communication framework where a number of devices share the channel based on random access operating under the protocol standards. The devices can operate in a half-duplex mode, in which information sent to one STA or AP is heard by all nodes on the network. The nodes activate listening only if the packet is addressed to them; otherwise, they ignore the transmission.

Wi-Fi sensing uses existing Wi-Fi signals to determine information about the environment. This can allow a receiver to use the L-LTF or any generational LTF to sense the channel and extract physical events or changes like motion, location from the sender and room models. Usually this relies on the receiver to passively sense the channel and listen to any packets transmitted. This usually leads to non-optimal sensing due to uncontrolled packet transmission and unsynchronized transmitter and receivers.

To address these and other issues, this disclosure provides systems and methods to enable radar mode for Wi-Fi devices using 802.11 frames. As described in more detail below, the disclosed embodiments enable a radar format for a single antenna use case with a duplexer. This allows the single antenna device to be able to switch between transmit and receive modes based on the requirements of the radar operation within the data part of the physical layer (PHY) PPDU. Since the transmitter and receiver are on the same device and use a common clock, this would resolve the issue of clock drifts that occurs in non-co-located transmitter and receivers.

The disclosed embodiments also enable radar format for multiple antenna use cases with simultaneous operation. This allows multiple antenna devices to overcome the near-distance blindness that occurs in some single antenna use cases due to the switching required between transmit and receive mode.

The disclosed embodiments also can reserve one or more Transmit Opportunities (TXOPs) to send a radar waveform. This allows the device practicing the radar operation to inform nearby devices that the TXOP is reserved and may not be impeded on. In addition, the disclosed embodiments enable mode switching between communication and radar during active traffic. This mode leverages the Target Wake Time operation, introduced in 802.11 ah and 802.11ax, that allows a station to schedule data communication periods with the AP or STA. During the mode that the device is not communicating, it can schedule the radar mode using any of the aforementioned techniques.

The disclosed embodiments provide multiple advantageous benefits over conventional systems that enable monostatic radar mode on Wi-Fi. For example, the disclosed embodiments provide independent radar operation on the Wi-Fi device for sensing capabilities. Thus, the Wi-Fi device is not dependent on active traffic from other devices or AP beacons for sensing. As another example, the disclosed embodiments provide deterministic information to other devices on the network about the duration of the operation, thus maintaining the existing efficiency of the Wi-Fi network. As yet another example, the disclosed embodiments provide standard compliant operations for enabling monostatic radar mode and reducing the amount of non-Wi-Fi interference due to radar operation. Also, the disclosed embodiments enable multi-antenna radar operations to enable continuous wave radar operation.

Note that while some of the embodiments discussed below are described in the context of smart phones, these are merely examples. It will be understood that the principles of this disclosure may be implemented in any number of other suitable contexts or systems, including other portable electronic devices (e.g., tablets, laptops, and the like).

Enabling Radar for Single Antenna with Duplexer.

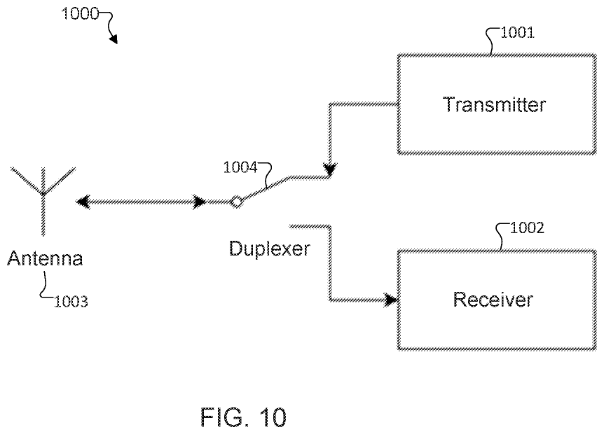

As mentioned before, Wi-Fi systems typically operate in half-duplex mode, either transmitting or receiving at a given time. The RF chain responsible for receiving and transmitting is alternated based on the mode required. In some embodiments, a duplexer is used to switch modes. For example, FIG. 10 illustrates an example Wi-Fi node 1000 that includes a duplexer switch for use in Wi-Fi according to various embodiments of the present disclosure. As shown in FIG. 10, the Wi-Fi node 1000 includes a transmitter chain 1001, a receiver chain 1002, an antenna 1003, and a duplexer switch 1004. The transmitter chain 1001 and receiver chain 1002 are activated based on the mode the Wi-Fi node 1000 is operating in. The duplexer switch 1004 is operated to switch modes from transmit to receive or vice versa.

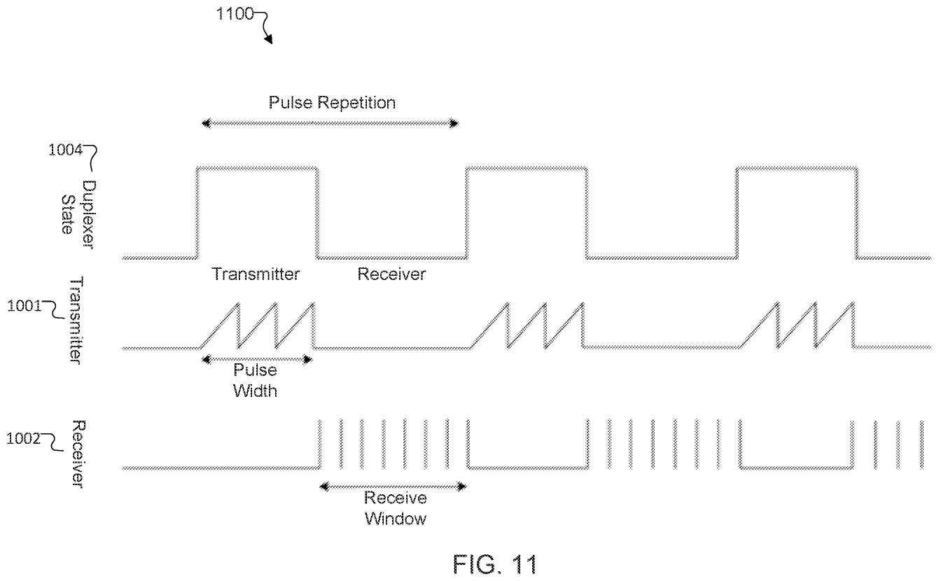

As radar pulses may be judged as non-Wi-Fi interference by other nodes, channel access for the radar should be carefully designed. To enable the monostatic radar mode, the operation can be shifted to the format shown in FIG. 11. FIG. 11 illustrates an example operation timeline 1100 for Wi-Fi radar mode using a single antenna according to various embodiments of the present disclosure. As shown in FIG. 11, the state of the duplexer 1004 alternates between transmitter mode and receiver mode. The pulse repetition is based on one pulse that includes both the transmitter mode and the receiver mode. During the transmitter mode (having a duration defined by the pulse width), the transmitter 1001 transmits, and during the receiver mode (having a duration defined by the receive window), the receiver 1002 receives.

Wi-Fi nodes treat non-Wi-Fi interference differently and will back off from transmitting if the energy detected is higher than a predetermined threshold (e.g., −62 dBm). Additionally, as the nodes are not aware of the duration of the non-Wi-Fi interference, this can lead to unnecessary effects like rate back-off and significant loss of throughput in the network. To avoid these secondary effects, the radar pulses can be designed to reuse 802.11 frames and embed the radar pulses in the data portion of the packet. This allows the network to know how long to back-off for, and also to use the packet detection threshold of −82 dBm instead of the energy detection threshold.

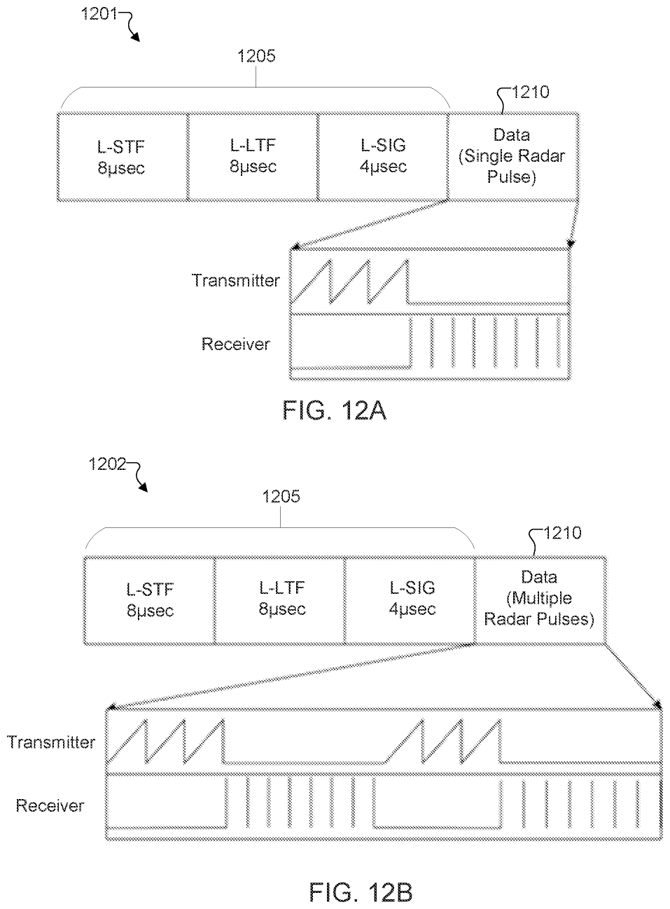

FIGS. 12A and 12B illustrate example formats for packets 1201 and 1202 for monostatic radar operation using a single antenna according to various embodiments of the present disclosure. FIGS. 12A and 12B show how radar pulses can be embedded in the legacy PPDU. In particular, FIG. 12A shows a mode having a single radar pulse per packet, and FIG. 12B shows a mode having multiple radar pulses per packet.

As shown in FIGS. 12A and 12B, the packets 1201 and 1202 are based on the 802.11 frame format and can be used by a single-antenna Wi-Fi node that includes a duplexer, such as the Wi-Fi node 1000 of FIG. 10. Each packet 1201 and 1202 is a PPDU that includes a preamble 1205 and a data field 1210. The preamble 1205 can have the same format as the preamble 900 of FIG. 9. The radar pulse(s) are transmitted and received within the duration of the data field 1210.

The radar pulse design here is important, since the length of the pulse affects the SNR of the received signal and also can impact the near-distance reflections. Thus, it can be important to balance the length of the radar pulse based on system requirements. As an example, a pulse length of 3.3 ns with no switching time between transmit and receive mode will miss all reflections from a 0.5 m radius around the antenna. This is because a radar pulse at the speed of light will travel 1 m from the reflection and back in 3.3 ns. The pulse period is also relevant to set the maximum detection distance required by the radar mode. The multiple pulse mode shown in FIG. 12B can be beneficial for boosting the SNR of the received signal.

In some embodiments, the radar pulse duration (i.e., the length of the radar pulse) is stored in the L-SIG field of the preamble 1205. In some embodiments, the duration of the radar pulse reception in the receive mode can be equal to or less than the smallest duration of time for which the channel is sensed (e.g., the Reduced Inter Frame Spacing (RIFS)) to prevent additional interference from OBSS packets that did not decode the duration field to update the NAV.

In some embodiments, to have a back-off on the MAC layer, the radar pulse can be embedded in the MAC data portion to a packet addressed to itself. An advantage of using the MAC data portion is that the PSR_AND_NON_SRG_OBSS_PD_PROHIBITED bit of the MAC header can be used to prevent OBSS nodes from performing spatial reuse over the current radar operation and increasing the interference in the current transmission.

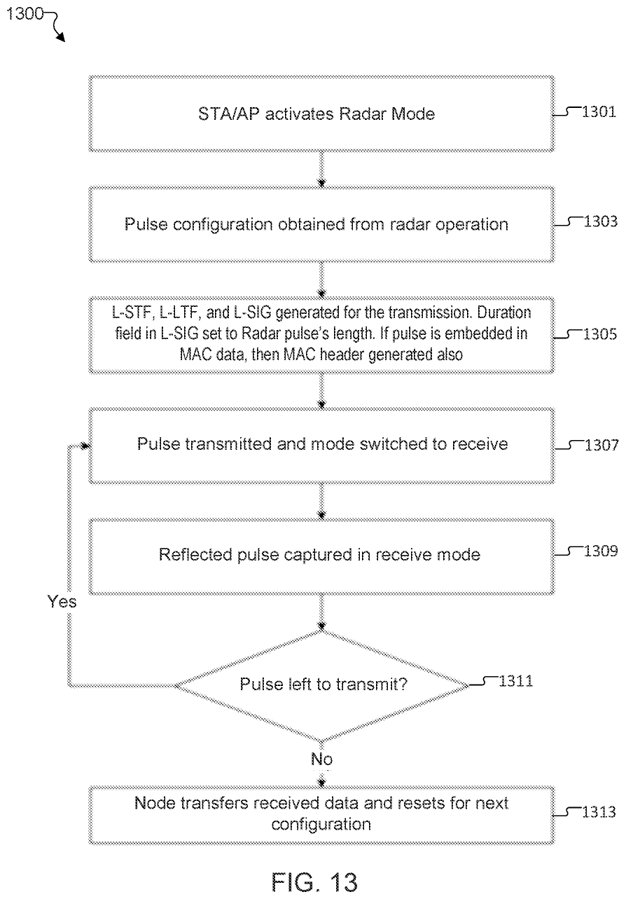

FIG. 13 illustrates an example process 1300 for configuring monostatic radar mode on a Wi-Fi node with a single antenna according to various embodiments of the present disclosure. As shown in FIG. 13, the process 1300 begins at operation 1301, where a STA or an AP activates radar mode. At operation 1303, the radar pulse configuration is obtained from the radar operation. At operation 1305, the L-STF field, the L-LTF field, and the L-SIG fields of the preamble are generated for the transmission. The duration field in the L-SIG field is set to the length of the radar pulse. If the pulse is embedded in MAC data, then the MAC header is also generated. At operation 1307, the Wi-Fi node transmits the pulse, and then the mode is switched to receive mode using the duplexer. At operation 1309, the Wi-Fi node captures the reflected pulse while in the receive mode. At operation 1311, the Wi-Fi node determines if there is another pulse to transmit. This may be the case if there are multiple radar pulses per packet, such as shown in FIG. 12B. If there is another pulse to transmit, the process 1300 returns to operation 1307 for the additional pulse. Otherwise, at operation 1313, the Wi-Fi node transfers the received data and resets for the next configuration.

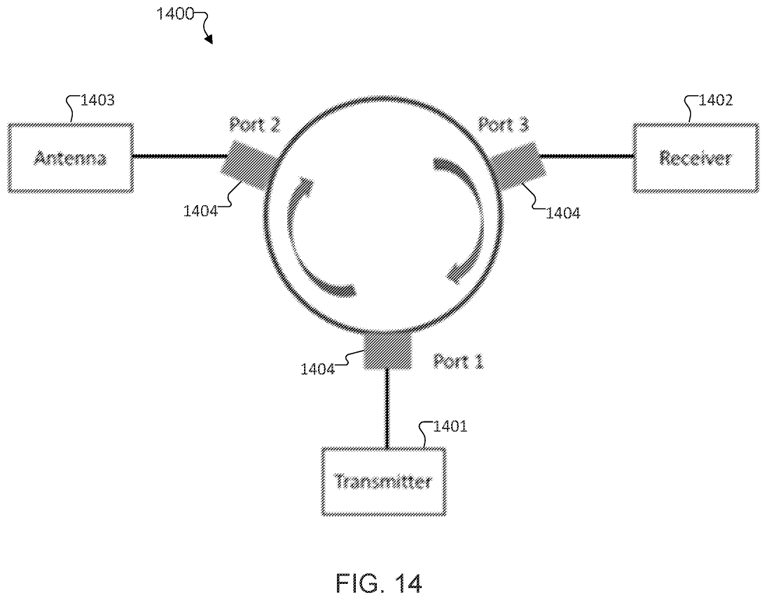

To turn the Wi-Fi system into a monostatic radar, RF isolation is needed between the transmitter and the receiver. A RF circulator can be added to serve as a duplexer to enable the WiFi system as a monostatic radar. FIG. 14 illustrates an example RF circulator 1400 according to various embodiments of the present disclosure. As shown in FIG. 14, the RF circulator 1400 includes at least one transmitter 1401, at least one receiver 1402, and at least one antenna 1403, and multiple ports 1404 (identified here as Port 1, Port 2, and Port 3). The RF circulator 1400 can operate as the duplexer for monostatic radar. The RF energy coupled into one port 1404 will only flow in a clockwise direction and emit out in the next port 1404. For example, the S-parameter for the RF circulator 1400 can be S21=−2 dB and S31=−60 dB. In some embodiments, the RF circulator 1400 can be constructed with ferrite, which enforces different RF propagation speeds when the RF energy flows in a different direction. Thus, the RF energy entering from Port 1 can add in-phase in Port 2 while adding out-of-phase in Port 3, which effectively mandates that the RF energy flow in a clockwise direction and emits in the next port adjacent from the source port.

Enabling Radar for Multi-Antenna with Duplexer.

In some embodiments, instead of a single antenna, the Wi-Fi node can have M antennas, where M>1. In such embodiments, the Wi-Fi node can switch m antenna(s) to transmit mode (where 1≤m<M), while M−m antenna(s) are switched to receive mode. In this configuration, the Wi-Fi node can be used as a monostatic radar.

The radar pulse that is generated will be similar to that of the single antenna case, but during the Data/Radar operation of the Wi-Fi node, the m antenna(s) will transmit radar pulses and the M−m antenna(s) will receive radar reflections simultaneously. This will remove the near distance constraint, since the receive antenna(s) can capture the signal even when the transmit antenna(s) are activated. This also allows using continuous wave operations during the radar phase of the transmission apart from pulse radar mode. Additionally, using multiple antennas removes the constraints of the pulse duration, because the minimum detection distance is not restricted to the switching time between transmit and receive mode.

TXOP to Send the Radar pulse using CTS-to-Self.

Clear to send (CTS)-to-self is a protection mechanism provided by IEEE 802.11 to reserve a TXOP. It is similar to a Request to send (RTS)/CTS sequence, but with less overhead as it does not require an extra RTS frame to be transmitted. The end of the TXOP is usually indicated by the transmission of an acknowledgement (ACK), or the end can be triggered by using a Contention Free (CF)-end packet.

The previously described embodiments include embedding the radar pulse in the data unit of the packet, either on the PHY layer or the MAC layer, depending on the capability of the devices on the network. This adds an overhead of transmitting the full PHY preamble or PHY+MAC header every time the radar operation needs to be performed. In contrast, in some embodiments, the monostatic radar operation of the Wi-Fi node can be enabled by reserving the transmit opportunity (TXOP) using the CTS-to-self frame and using the contention free burst interval to perform the radar operation.

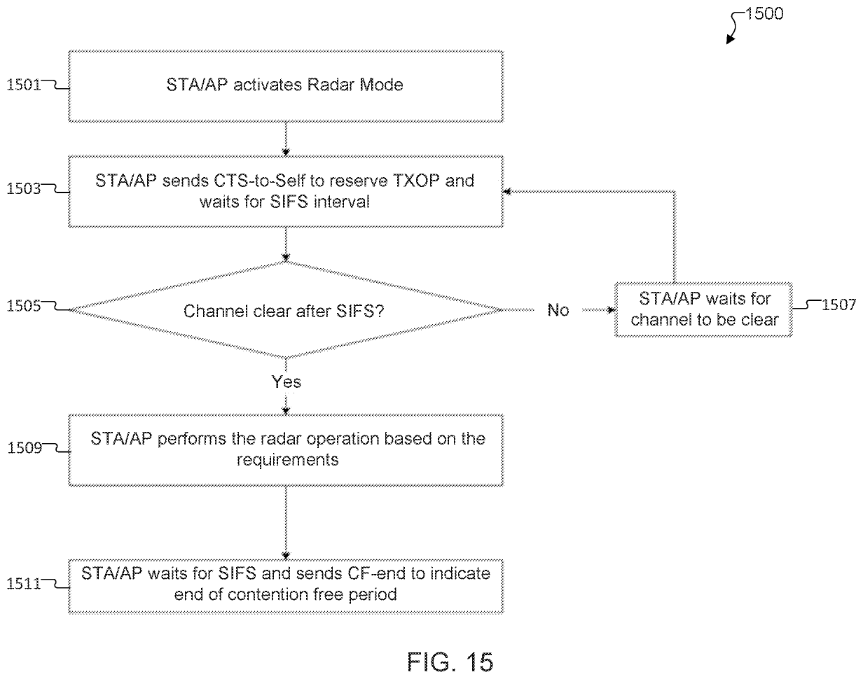

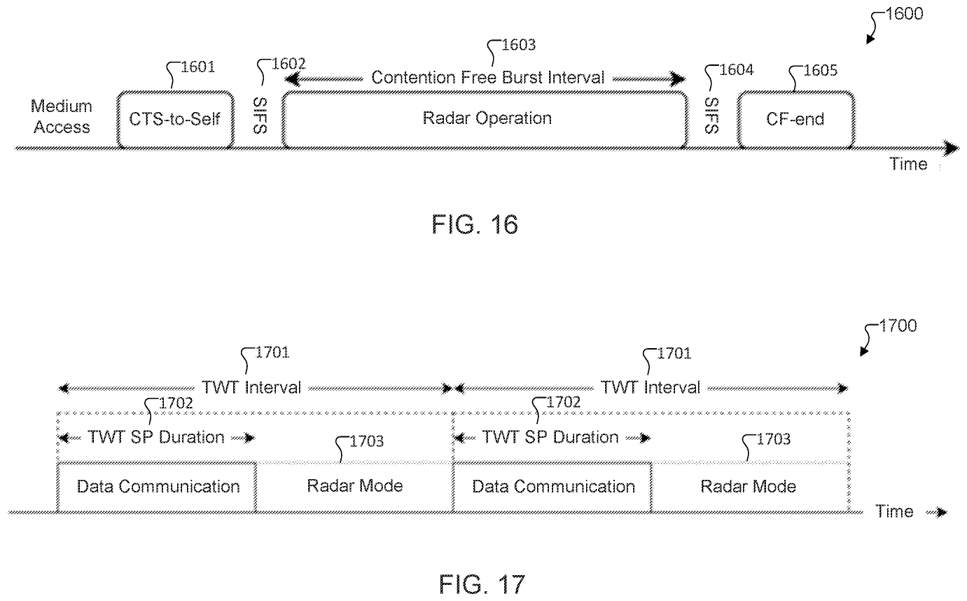

For example, FIG. 15 illustrates an example process 1500 for performing radar operation using reserved TXOP with CTS-to-self according to various embodiments of the present disclosure. FIG. 16 illustrates an example timeline 1600 in which radar operation is enabled using CTS-to-self according to various embodiments of the present disclosure. The timeline 1600 corresponds to the process 1500. As shown in FIG. 15, the process 1500 begins at operation 1501. At operation 1501, a STA or an AP activates radar mode. At operation 1503, the STA or AP sends a CTS-to-self frame 1601 to reserve a TXOP, and then waits during the short interframe space (SIFS) interval 1602. At operation 1505, the STA or AP determines if the channel is clear after the SIFS interval 1602. If the channel is not clear, then at operation 1507, the STA or AP waits for the channel to be clear and the process 1500 returns to operation 1503. If the channel is clear, then at operation 1509, the STA or AP performs the radar operation (i.e., radar transmitting and receiving) during the contention free burst interval 1603. At operation 1511, the STA or AP waits during another SIFS 1604, and then sends a CF-end 1605 to indicate the end of the contention free period. In some embodiments, the receive modes can be mandated to be less than the RIFS duration to prevent the channel from being sensed as idle by other nodes and to prevent interference.

Switching between Radar and Communication Mode using TWT.

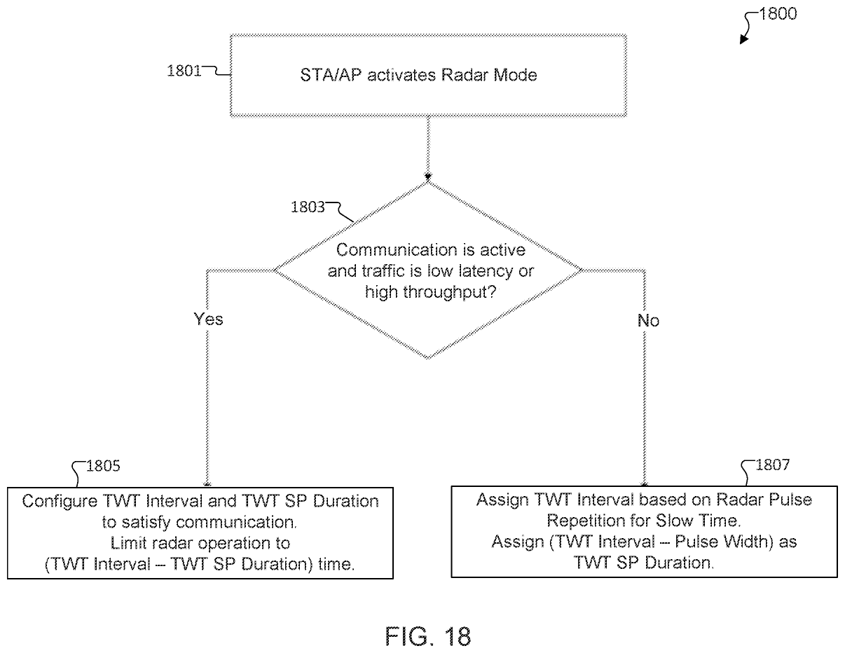

To operate the radar operation on a Wi-Fi node during active communication, TWT can be used to allocate the time between communication and radar mode. Based on the amount of data and type of service on the device, the TWT Interval and the TWT SP Duration can be assigned accordingly. FIG. 17 illustrates an example timeline 1700 showing how time can be divided between radar mode and communication for a Wi-Fi node using TWT according to various embodiments of the present disclosure. FIG. 18 illustrates an example process 1800 for assigning the TWT Interval and TWT SP Duration based on the priority of the communications traffic according to various embodiments of the present disclosure. The timeline 1700 corresponds to the process 1800.

As shown in FIG. 18, the process 1800 begins at operation 1801. At operation 1801, a STA or an AP activates radar mode. At operation 1803, the STA or the AP determines if communication is active, and traffic is low latency or high throughput. This could include, for example, comparing the level of communication or traffic to a predetermined threshold level. If it is determined that communication is active, then at operation 1805, the STA or AP configures the TWT Interval 1701 and the TWT SP Duration 1702 to satisfy the communication level. The STA or AP then limits radar operation 1703 to the portion of the time period of the TWT Interval 1701 outside of the TWT SP Duration 1702 (i.e., TWT Interval 1701−TWT SP Duration 1702). Alternatively, if it is determined that communication is not active, then at operation 1807, the STA or AP assigns the TWT Interval 1701 based on the radar pulse repetition for slow time. The STA or AP then assigns the TWT SP Duration 1702 as the TWT Interval 1701 minus radar pulse width.

In some embodiments, radar mode can be disabled to prioritize communications. In some embodiments, the communication efficiency can be reduced if radar mode is required by assigning a lower than estimated TWT SP Duration 1702 for communication.

In some embodiments, the TWT SP Duration 1702 negotiated with the AP is restricted for radar mode only and the STA performs the radar operation during the TWT SP Duration 1702 only. The STA communicates with the AP or remains in doze state otherwise.

The STA or AP can also define a TWT mode specifically for radar operation. The STA or AP can reuse the restricted TWT mode and reserve a restricted TWT session for radar mode only. Additionally, the STA or AP could also define a special broadcast TWT specifically for radar mode if restricted TWT mode cannot be used. In this case, the AP will inform the participating STAs of a code-book with near orthogonal radar signals to allow the STAs to use the special TWT SP Duration in parallel without causing significant interference. In another embodiment, the AP can indicate transmission parameters to achieve the same effect. In an additional embodiment, the AP can act as a transmitter, and all STAs can listen to the transmitted signal to behave as a bistatic radar use case. This can also provide another embodiment where all the STAs and the AP participating in the special TWT radar session, and can perform collaborative radar operation where the TWT SP Duration is divided into slots. In each slot, one or more AP/STAs can act as transmitter and the rest can act as receivers to function as a diverse bistatic radar case.

Although FIGS. 10 through 18 illustrate example techniques to enable radar mode for Wi-Fi devices and related details, various changes may be made to FIGS. 10 through 18. For example, various components in FIGS. 10 through 18 could be combined, further subdivided, or omitted and additional components could be added according to particular needs. In addition, while shown as a series of steps, various operations in FIGS. 10 through 18 could overlap, occur in parallel, occur in a different order, or occur any number of times. In another example, steps may be omitted or replaced by other steps.

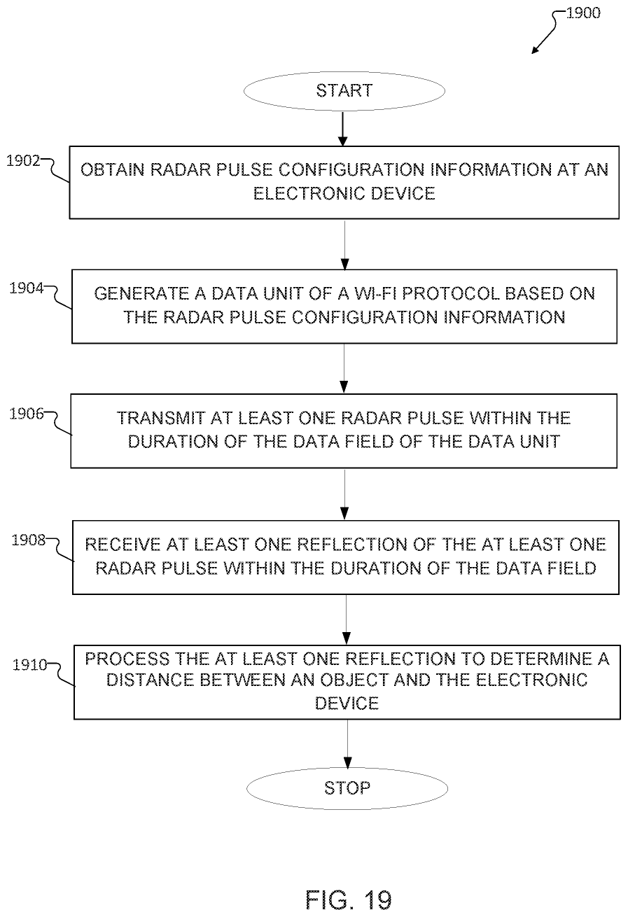

FIG. 19 illustrates a flow chart of a method 1900 for enabling radar mode for Wi-Fi devices according to various embodiments of the present disclosure, as may be performed by one or more components of the wireless network 100 (e.g., the STA 111). The embodiment of the method 1900 shown in FIG. 19 is for illustration only. One or more of the components illustrated in FIG. 19 can be implemented in specialized circuitry configured to perform the noted functions or one or more of the components can be implemented by one or more processors executing instructions to perform the noted functions.

As illustrated in FIG. 19, the method 1900 begins at step 1902. At step 1902, a Wi-Fi node obtains radar pulse configuration information. This could include, for example, the STA 111 obtaining the radar pulse configuration from the activated radar operation, such as described in FIG. 13.

At step 1904, the Wi-Fi node generates a data unit of a Wi-Fi communications protocol based on the radar pulse configuration information. The data unit comprises a preamble and a data field. This could include, for example, the STA 111 generating a PPDU packet 1201 or 1202, which includes a preamble 1205 and a data field 1210.

At step 1906, the Wi-Fi node transmits at least one radar pulse within a duration of the data field. This could include, for example, the STA 111 transmitting one or more radar pulses in the data field 1210, such as shown in FIGS. 12A and 12B.

At step 1908, the Wi-Fi node receives at least one reflection of the at least one radar pulse within the duration of the data field. This could include, for example, the STA 111 receiving one or more radar reflections in the data field 1210, such as shown in FIGS. 12A and 12B.

At step 1910, the Wi-Fi node processes the at least one reflection to determine a distance between an object and the Wi-Fi node. This could include, for example, the STA 111 determining a distance of a target object 325 on which the radar pulse is reflected, such as described in conjunction with FIG. 3.

Although FIG. 19 illustrates one example of a method 1900 for enabling radar mode for Wi-Fi devices, various changes may be made to FIG. 19. For example, while shown as a series of steps, various steps in FIG. 19 could overlap, occur in parallel, occur in a different order, or occur any number of times.

Although the present disclosure has been described with an exemplary embodiment, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined by the claims.

What is claimed is:

1. A method comprising:
obtaining radar pulse configuration information at an electronic device;
generating a data unit of a Wi-Fi communications protocol based on the radar pulse configuration information, the data unit comprising a preamble and a data field;
transmitting at least one radar pulse within a duration of the data field;
receiving at least one reflection of the at least one radar pulse within the duration of the data field; and
processing the at least one reflection to determine a distance between an object and the electronic device.

2. The method of claim 1, wherein a radar pulse duration included in the radar pulse configuration information is stored in the preamble of the data unit.

3. The method of claim 1, wherein:
radar pulse transmission and radar pulse reception is performed in the data field of the data unit; and
a duration of the radar pulse reception is less than a reduced interframe spacing (RIFS) time of the Wi-Fi communications protocol.

4. The method of claim 1, wherein:
the at least one radar pulse is transmitted by an antenna of the electronic device;
the method further comprises switching from a transmit mode to a receive mode; and
the at least one reflection is received within the duration of the data field by the antenna of the electronic device.

5. The method of claim 1, wherein:
the at least one radar pulse is transmitted by at least one first antenna of the electronic device; and
the at least one reflection is simultaneously received by at least one second antenna of the electronic device within the duration of the data field.

6. The method of claim 1, further comprising:
transmitting a clear-to-send (CTS)-to-self signal to reserve a transmit opportunity (TXOP); and
after transmitting the at least one radar pulse and receiving the at least one reflection, sending a contention free (CF)-end packet to indicate an end of a contention-free period,
wherein the at least one radar pulse is transmitted and the at least one reflection is received in response to determining that a communications channel is clear after a first short interframe spacing (SIFS) duration.

7. The method of claim 1, further comprising:
configuring a target wake time (TWT) interval and a TWT service period (SP) duration in response to determining that low latency or high throughput Wi-Fi traffic exists,
wherein the at least one radar pulse is transmitted and the at least one reflection is received within the TWT interval and after the TWT SP duration.

8. A device comprising:
a transceiver; and
a processor operably connected to the transceiver, the processor configured to:
obtain radar pulse configuration information;
generate a data unit of a Wi-Fi communications protocol based on the radar pulse configuration information, the data unit comprising a preamble and a data field;
transmit at least one radar pulse within a duration of the data field;
receive at least one reflection of the at least one radar pulse within the duration of the data field; and
process the at least one reflection to determine a distance between an object and the device.

9. The device of claim 8, wherein a radar pulse duration included in the radar pulse configuration information is stored in the preamble of the data unit.

10. The device of claim 8, wherein:
the processor is configured to perform radar pulse transmission and radar pulse reception in the data field of the data unit; and
a duration of the radar pulse reception is less than a reduced interframe spacing (RIFS) time of the Wi-Fi communications protocol.

11. The device of claim 8, further comprising:
an antenna configured to transmit the at least one radar pulse,
wherein the processor is further configured to switch from a transmit mode to a receive mode; and
wherein the processor is configured to receive the at least one reflection within the duration of the data field.

12. The device of claim 8, further comprising:
at least one first antenna configured to transmit the at least one radar pulse; and
at least one second antenna configured to simultaneously receive the at least one reflection within the duration of the data field.

13. The device of claim 8, wherein the processor is further configured to:
transmit a clear-to-send (CTS)-to-self signal to reserve a transmit opportunity (TXOP); and
after transmitting the at least one radar pulse and receiving the at least one reflection, send a contention free (CF)-end packet to indicate an end of a contention-free period,
wherein the processor is configured to transmit the at least one radar pulse and receive the at least one reflection in response to determining that a communications channel is clear after a first short interframe spacing (SIFS) duration.

14. The device of claim 8, wherein the processor is further configured to:
configure a target wake time (TWT) interval and a TWT service period (SP) duration in response to determining that low latency or high throughput Wi-Fi traffic exists,
wherein the processor is configured to transmit the at least one radar pulse and receive the at least one reflection within the TWT interval and after the TWT SP duration.

15. A non-transitory computer readable medium comprising program code that, when executed by a processor of a device, causes the device to:
obtain radar pulse configuration information;
generate a data unit of a Wi-Fi communications protocol based on the radar pulse configuration information, the data unit comprising a preamble and a data field;
transmit at least one radar pulse within a duration of the data field;
receive at least one reflection of the at least one radar pulse within the duration of the data field; and
process the at least one reflection to determine a distance between an object and the device.

16. The non-transitory computer readable medium of claim 15, wherein a radar pulse duration included in the radar pulse configuration information is stored in the preamble of the data unit.

17. The non-transitory computer readable medium of claim 15, wherein:
the program code, when executed by the processor, causes the device to perform radar pulse transmission and radar pulse reception in the data field of the data unit; and
a duration of the radar pulse reception is less than a reduced interframe spacing (RIFS) time of the Wi-Fi communications protocol.

18. The non-transitory computer readable medium of claim 15, wherein the program code, when executed by the processor, further causes the device to:
transmit the at least one radar pulse via an antenna of the device;
switch from a transmit mode to a receive mode; and
receive the at least one reflection within the duration of the data field via the antenna.

19. The non-transitory computer readable medium of claim 15, wherein the program code, when executed by the processor, further causes the device to:
transmit the at least one radar pulse via at least one first antenna; and
simultaneously receive the at least one reflection via at least one second antenna within the duration of the data field.

20. The non-transitory computer readable medium of claim 15, wherein the program code, when executed by the processor, further causes the device to:
transmit a clear-to-send (CTS)-to-self signal to reserve a transmit opportunity (TXOP);
after transmitting the at least one radar pulse and receiving the at least one reflection, send a contention free (CF)-end packet to indicate an end of a contention-free period; and
transmit the at least one radar pulse and receive the at least one reflection in response to determining that a communications channel is clear after a first short interframe spacing (SIFS) duration.
